(19) United States
(12) Patent Application Publication
(10) Pub. No.: US 2012/0229653 A1
(43) Pub. Date: Sep. 13, 2012

(54) CONTROL METHOD FOR TV SYSTEM

(75) Inventors: Chen-Yung Lien, Hsinchu City (TW); Ming-Chang Lin, Hsinchu City (TW)

(73) Assignee: Sunplus Technology Co., Ltd., Hsinchu (TW)

(21) Appl. No.: 13/354,505

(22) Filed: Jan. 20, 2012

(30) Foreign Application Priority Data
Mar. 10, 2011 (TW) 100108173

(51) Int. Cl. H04N 17/00

(52) U.S. Cl. 348/192; 348/E17.003

(57) ABSTRACT

A control method for a TV system is provided. The TV system has a digital signal port connected to a player. The control method includes the following steps. After the TV system is turned on, a first set value is written into an EDID rewritable memory of the TV system. After the player is connected to the TV system, the TV system judges whether a quality of the first digital signal group is good or bad. If the quality of the first digital signal group is good, a video/audio signal is issued by the TV system according to the first digital signal group. Whereas, if the quality of the first digital signal group is bad, a second set value is written into the EDID rewritable memory.

This application claims the benefit of Taiwanese Patent Application No. 100108173, filed Mar. 10, 2011, the subject matter of which is incorporated herein by reference.

### FIELD OF THE INVENTION

The present invention relates to a control method for a TV system, and more particularly to a control method for a TV system in order to change the transmission specifications of the digital signal port according to the video quality.

### BACKGROUND OF THE INVENTION

With increasing development of science and technology, the current TV system is able to receive digital video signals and digital audio signals. In addition, the above TV system for receiving digital video signals and digital audio signals gradually replaces the conventional TV system for receiving analog video signals and analog audio signals. The TV system has a digital signal port for receiving the digital video signals. For example, the digital signal port is a high-definition multimedia interface (HDMI) port, a digital visual interface (DVI) port or a display port.

FIG. 1 is a schematic functional block diagram illustrating the connection between a TV system and a player, which support HDMI specifications. The player 100 is for example a DVD player, a BD player or a HD media player. Moreover, the player 100 and the TV system 200 are in communication with each other through a HDMI cable 150.

The signal groups of the HDMI cable 150 comprises a transition minimized differential signaling (TMDS) signal group and a control signal. The TMDS signal group comprises a channel 0 signal, a channel 1 signal, a channel 2 signal, and a clock channel signal (CLK channel signal). The control signal is a display data channel signal. Moreover, the TMDS signal group is a digital signal group and at least comprises digital video signals.

The player 100 comprises a playback control unit 102 and a HDMI transmitter 104. The video/audio data stored in a storage device (not shown) may be read by the playback control unit 102. Depending on the type of the player 102, the storage device is a DVD drive, BD drive or a hard drive that is installed in the player 100.

After the video/audio data are received by the playback control unit 102, a video signal (video1) and an audio signal (audio1) are sent to the HDMI transmitter 104. According to a control/status signal (control1/status1), the video signal (video1) and the audio signal (audio1) are converted into the TMDS signal group by the HDMI transmitter 104. Then, the TMDS signal group is transmitted from the HDMI transmitter 104 to the TV system 200 through the HDMI cable 150. From the above discussions, the player 100 may be considered as a signal source for providing the TMDS signal group to the TV system 200. In other words, the TMDS signal group comprises digital video signals and digital audio signals.

After the TMDS signal group is received by the HDMI receiver 202 of the TV system 200, a video signal (video2), an audio signal (audio2) and a control/status signal (control2/status2) is issued from the HDMI receiver 202 to the microcontroller 204. Under control of the microcontroller 204, the video signal (video2) is shown on a screen (not shown) and the audio signal (audio2) is outputted through a speaker (not shown). From the above discussions, the TV system 200 may be considered as a signal sink for receiving the TMDS signal group from the signal source.

Generally, before the player 100 starts to transmit the TMDS signal group to the TV system 200, the player 100 should realize the specifications supported by the TV system 200 and output the signals complying with the specifications to the TV system 200. In addition, the TV system 200 has an extended display identification data read only memory (also referred to as EDID ROM) 206 for informing the player 100 about the supportable formats of the TV system 200. Take the HDMI 1.3 standard for example. It supports the 24-bit, 30-bit, 36-bit or 48-bit deep color video mode. A higher bit number denotes a higher format supported by the TV system 200 and a faster speed of the TMDS signal group.

Of course, before the TV system 200 leaves the factory, the set value of the supported formats is previously recorded in the EDID ROM 206. After the player 100 (signal source) is in communication with the TV system 200 (signal sink), the set value in the EDID ROM 206 will be read out by the playback control unit 102 of the player 100 through the display data channel. In such way, the formats supported by the TV system 200 are realized by the player 100.

In a case that player 100 is able to play any format of data, after the set value in the EDID ROM 206 is read by the player 100, the HDMI transmitter 104 is controlled to transmit digital signals according to highest specification supported by the TV system 200.

For example, if the TV system 200 is able to support all of the 24-bit, 30-bit and 36-bit deep color video modes, the HDMI transmitter 104 of the player 100 is controlled to output the TMDS signal group (i.e. the channel 0 signal, the channel 1 signal, the channel 2 signal and the clock channel signal) that supports the 36-bit deep color video mode.

Since the set value of the supported format recorded in the EDID ROM 206 fails to be changed after the TV system 200 leaves the factory, the TV system 200 can not normally output video/audio signals in some situations. In practical applications, if an unqualified HDMI cable 150, a poor-quality HDMI cable 150 or an aged HDMI cable 150 is employed, the quality of the TMDS signal group is deteriorated and fails to meet the requirements of the specifications. Under this circumstance, the player 100 fails to realize that the quality of the TMDS signal group is deteriorated, and the TV system fails to normally output the video/audio signals.

### SUMMARY OF THE INVENTION

The present invention provides a control method for a TV system. The TV system has a digital signal port connected to a player. The control method includes the following steps. Firstly, the TV system is turned on, and a first set value is written into an extended display identification data (EDID) rewritable memory of the TV system. After the player is connected to the TV system, the player reads the first set value of the EDID rewritable memory to acquire a first specification supported by the TV system, so that a first digital signal group is transmitted from the player to the TV system. Then, the TV system judges whether a quality of the first digital signal group is good or bad. If the quality of the first digital signal group is good, a video/audio signal is outputted from the TV system according to the first digital signal group. Whereas, if the quality of the first digital signal group is bad, a second set value is written into the EDID rewritable memory.

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 (prior art) is a schematic functional block diagram illustrating the connection between a TV system and a player, which support HDMI specifications;

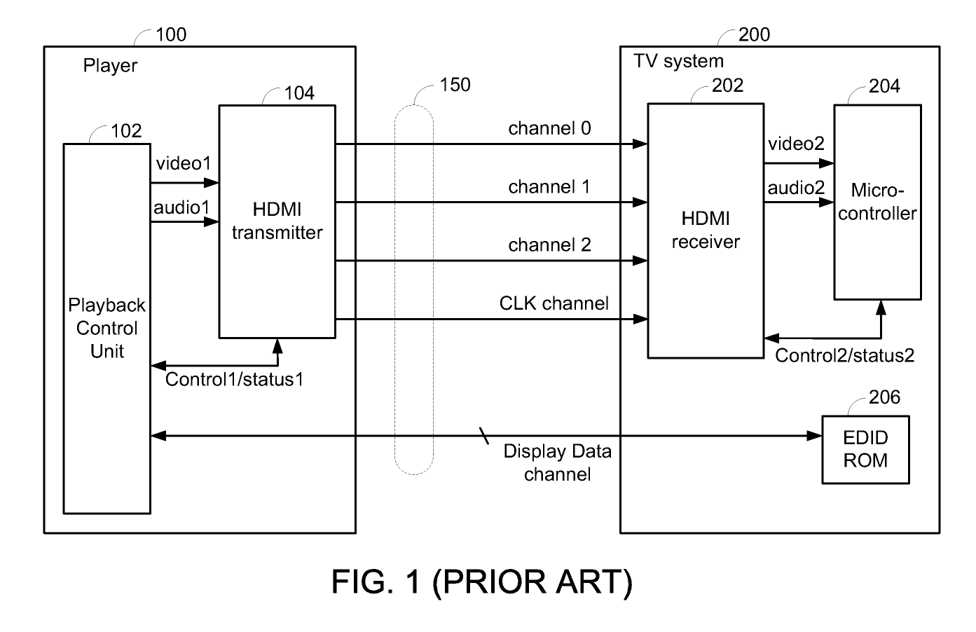

FIG. 2 schematically illustrates a data block of an extended display identification data read only memory (EDID ROM);

FIG. 3 is a schematic functional block diagram illustrating the connection between a TV system and a player supporting HDMI specifications according to an embodiment of the present invention;

FIG. 4 is a flowchart illustrating a control method for a TV system according to an embodiment of the present invention; and

FIGS. 5A˜5D schematically illustrate various set values of the EDID rewritable memory of the TV system.

### DETAILED DESCRIPTION OF PREFERRED EMBODIMENTS

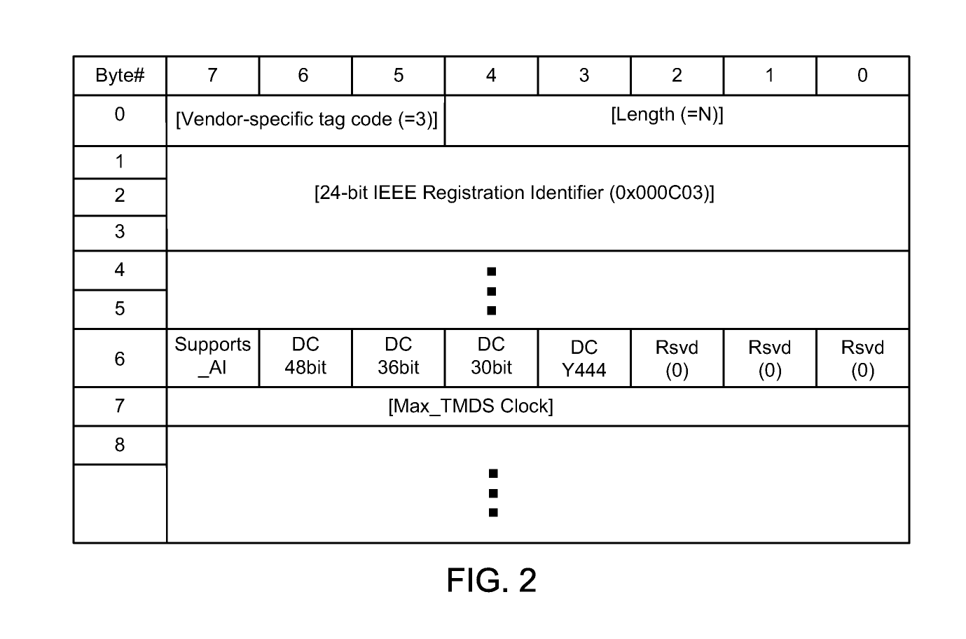

Please refer to FIG. 2, which schematically illustrates a data block of an extended display identification data read only memory (EDID ROM). The data block is an HDMI-LLC vendor-specific data block (also referred to as HDMI VSDB).

The supportable deep color video modes in the RGB color gamut can be realized from the contents of the sixth byte of the vendor-specific data block, including the sixth bit (DC 48 bit), the fifth bit (DC 36 bit) and the fourth bit (DC 30 bit. For example, the three bits (1, 1, 1) indicate that the TV system supports the 48-bit deep color video mode, the 36-bit deep color video mode, the 30-bit deep color video mode and the 24-bit deep color video mode. Similarly, the three bits (0, 0, 1) indicate that the TV system supports the 30-bit deep color video mode and the 24-bit deep color video mode. Similarly, the three bits (0, 0, 0) indicate that the TV system supports 24-bit deep color video mode.

In the sixth byte of the vendor-specific data block, the third bit (DC Y444) denotes the deep color video modes in the YCrCb color gamut. If this bit is “1”, it means that the TV system supports the deep color video modes in the YCrCb color gamut.

Moreover, the seventh byte of the vendor-specific data block denotes the maximum TMDS clock setting (Max_TMDS_Clock) supported by the TV system, i.e. the clock setting of the clock channel signal (CLK channel signal). The settings of the other regions of this data block (e.g. the vendor-specific tag code, the 24-bit IEEE registration identifier, and the like) are not the subject matters of the present invention, and are not redundantly described herein.

Moreover, the EDID ROM further comprises a timing table list. The supportable resolutions for the TV system may be recorded in the timing table list. For example, the resolutions include 1920×1080p/60 Hz, 1920×1080i/60 Hz, and 1280×720p/60 Hz. From the above discussions, the player can realize the supported formats of the TV system according to the set value of the EDID ROM. Consequently, the TMDS signal group is transmitted to the TV system according to the highest specification supported by the TV system.

For example, in an embodiment, the set value of the sixth byte of the vendor-specific data block is (x, 0, 1, 1, 0, 0, 0, 0), the set value of the seventh byte of the vendor-specific data block is (0×2D), and the resolutions recorded in the timing table list are 1920×1080p/60 Hz, 1920×1080i/60 Hz, and 1280×720p/60 Hz. From the above settings, it is found that the maximum resolution supported by the TV system is 1920×1080p/60 Hz, the maximum deep color video mode supported by the TV system is the 36-bit deep color video mode, and the maximum TMDS clock setting is 225 MHz. Consequently, the TMDS signal group is transmitted from the HDMI transmitter to the TV system according to the highest specification supported by the TV system (i.e. 1920×1080p/60 Hz 36 bit).

In accordance with a key feature of the present invention, the extended display identification data rewritable memory (also referred to as an EDID rewritable memory) is employed to replace the extended display identification data read only memory (EDID ROM) of the conventional TV system because the contents of the EDID ROM are unchangeable. An example of the EDID rewritable memory includes but is not limited to an electrically-erasable programmable read only memory (EEPROM), a flash memory, a static random access memory (SRAM), or the like.

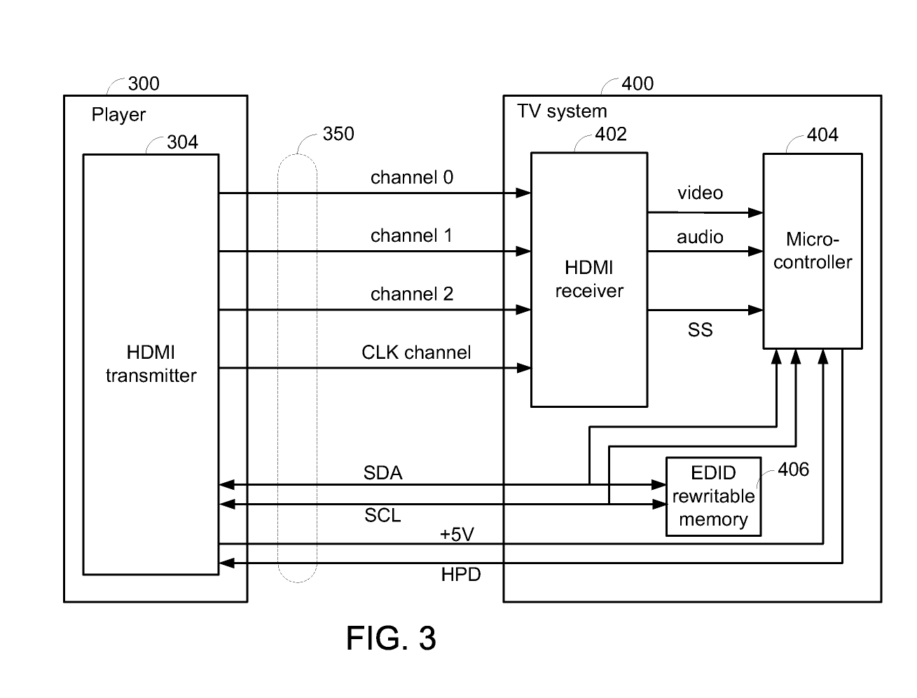

FIG. 3 is a schematic functional block diagram illustrating the connection between a TV system and a player supporting HDMI specifications according to an embodiment of the present invention. An example of the player 300 includes but is not limited to a DVD player, a BD player or a HD media player. Moreover, the player 300 and the TV system 400 are in communication with each other through a HDMI cable 350.

The player 300 may be considered as a signal source. In addition, the player 300 has a HDMI transmitter 304 for outputting the TMDS signal group to the TV system 400 through the HDMI cable 350. The TMDS signal group comprises a channel 0 signal, a channel 1 signal, a channel 2 signal, and a clock channel signal (CLK channel signal).

Moreover, the TV system 400 may be considered as a signal sink. The TV system 400 comprises a HDMI receiver 402, a microcontroller 404 and an EDID rewritable memory 406. After the TMDS signal group is received by the HDMI receiver 402 of the TV system 400, a video signal and an audio signal are transmitted to the microcontroller 404. Under control of the microcontroller 404, the video signal is shown on a screen (not shown) and the audio signal is outputted through a speaker (not shown).

In this embodiment, a quality signal SS is further outputted from the HDMI receiver 402 to the microcontroller 404 for informing the microcontroller 404 about the quality of the TMDS signal group. For example, during the TMDS signal group is converted into the video signal by the HDMI receiver 402, if the TMDS signal group can be accurately converted into the horizontal synchronization signal (Hsync) and the vertical synchronization signal (Vsync), the TMDS signal group is determined to have good quality. On the contrary, if the TMDS signal group fails to be accurately converted into the horizontal synchronization signal (Hsync) and the vertical synchronization signal (Vsync), the TMDS signal group is determined to have bad quality.

If the quality signal SS indicates that the quality of the TMDS signal group is bad, the set value of the EDID rewritable memory 406 may be changed by the microcontroller 404. After the set value in the EDID rewritable memory 406 is changed, the voltage level of a hot-plug detecting pin (also referred to as HPD pin) of the TV system 400 is changed by the microcontroller 404. Consequently, the player 300 judges that the HDMI cable 350 is disconnected from the player 300 and then plugged to the player 300. Under this circumstance, the player 300 needs to read the set value in the EDID rewritable memory 406 again, and can realize the highest supported specification of the set value in advance. Moreover, the HDMI transmitter 304 is employed to transmit the TMDS signal group.

According to the HDMI specification, the HDMI cable 350 comprises a HPD pin, a 5-volt pin (+5V), a serial data line (SDA), and a serial clock line (SCL) are used for transmitting the control signal. The serial data line (SDA) and the serial clock line (SCL) comply with the specification of the inter-integrated circuit (also referred to as I²C). By means of the 5-volt pin (+5V) provided by the player 300, the TV system 400 can detect whether the HDMI cable 350 is connected to the player 300. According to the voltage level of the HPD pin, the player 300 can detect whether the HDMI cable 350 is disconnected. That is, in a case that the HPD pin is controlled by the microcontroller 404 to be switched from a high voltage level to a low voltage level for a certain time period and then returned to the high voltage level, the HPD pin is triggered. After the HPD pin is triggered by the microcontroller 404, the player 300 judges that the HDMI cable 350 is disconnected from the player 300 and then plugged to the player 300.

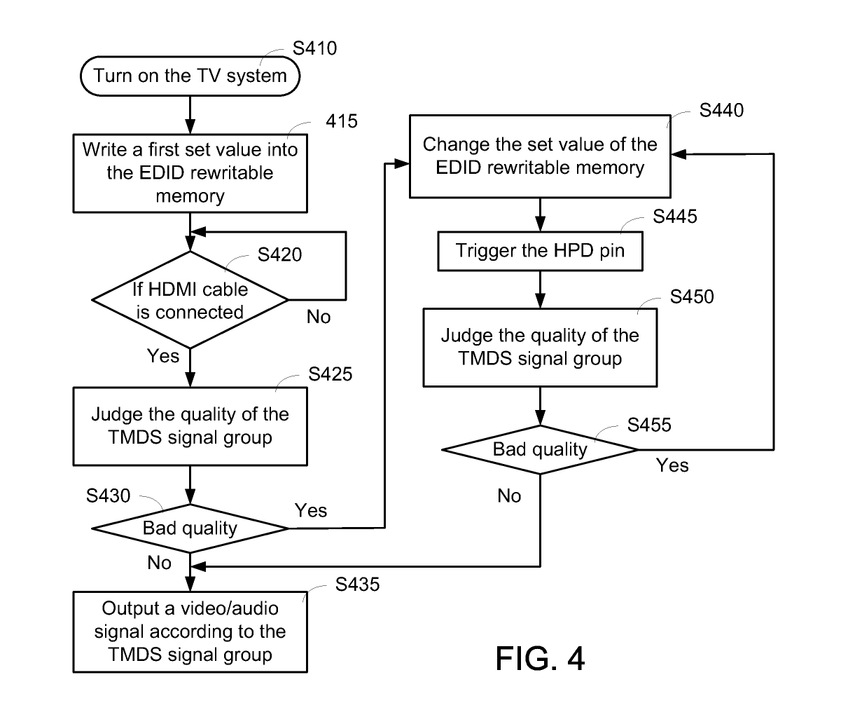

FIG. 4 is a flowchart illustrating a control method for a TV system according to an embodiment of the present invention. After the TV system 400 is turned on or the HPD pin is triggered, a read command is issued through the serial data line (SDA) and the serial clock line (SCL). According to read command, the set value of the EDID rewritable memory 406 is read. Moreover, according to the setting values, the player can realize the highest specification supported by the TV system 400, thereby generating the TMDS signal group (e.g. the channel 0 signal, the channel 1 signal, the channel 2 signal, and the clock channel signal).

Please refer to FIG. 4. After the TV system 400 is turned on (Step S410), the microcontroller 404 will write an initial set value (e.g. a first set value) into the EDID rewritable memory 406 (Step S415). Then, by means of the 5-volt pin (+5V), the TV system 400 detects whether the player 300 is connected with the TV system 400 through the HDMI cable 350 (Step S420).

After the connection between the player 300 and the TV system 400 is confirmed, the TMDS signal group (e.g. the channel 0 signal, the channel 1 signal, the channel 2 signal, and the clock channel signal) is received by the HDMI receiver 402. Then, the step S425 is performed to judge the quality of the TMDS signal group. According to the quality signal SS outputted from the HDMI receiver 402, the quality of the TMDS signal group can be realized by the microcontroller 404.

If the quality of the TMDS signal group is good (Step S430), a video/audio signal is outputted from the TV system 400 according to the TMDS signal group (e.g. the channel 0 signal, the channel 1 signal, the channel 2 signal, and the clock channel signal) (Step S435).

On the other hand, if quality of the TMDS signal group is bad (Step S430), the set value of the EDID rewritable memory 406 is changed by the microcontroller 404 (Step S440). For example, the first set value is changed to a second set value.

After the set value of the EDID rewritable memory 406 is changed, the HPD pin is triggered by the microcontroller 404 (Step S445). Then, the TMDS signal group (e.g. the channel 0 signal, the channel 1 signal, the channel 2 signal, and the clock channel signal) is received by the HDMI receiver 402, and the step S425 is performed to judge the quality of the TMDS signal group (Step S450). According to the quality signal SS outputted from the HDMI receiver 402, the quality of the TMDS signal group can be realized by the microcontroller 404.

If the quality of the TMDS signal group is good (Step S445), a video/audio signal is outputted from the TV system 400 according to the TMDS signal group (e.g. the channel 0 signal, the channel 1 signal, the channel 2 signal, and the clock channel signal) (Step S435).

On the other hand, if quality of the TMDS signal group is bad (Step S445), the set value of the EDID rewritable memory 406 is changed by the microcontroller 404 again (Step S440). For example, the second set value is changed to a third set value. The steps S440, S445, S450 and S455 are repeatedly done. In a case that the set value has been changed for several times and the quality of the TMDS signal group is still unsatisfied, the whole judging process may be terminated. In addition, a message may be shown on the screen to notify the user that no display mode is available.

From the above discussions, if the TV system 400 judges that the quality of the TMDS signal group is bad according to the quality signal SS, the set value of the EDID rewritable memory 406 is changed. Then, the HPD pin is re-triggered, and the set value of the EDID rewritable memory 406 is read by the player 300 again. Consequently, the TMDS signal group is transmitted from the HDMI transmitter 304 again.

After the set value of the EDID rewritable memory 406 is changed, the quality of the TMDS signal group can be improved, and thus the TMDS signal group can be normally outputted from the TV system. Hereinafter, some examples of allowing the player 300 to change the TMDS signal group by changing the set value of the EDID rewritable memory 406 will be illustrated in more details.

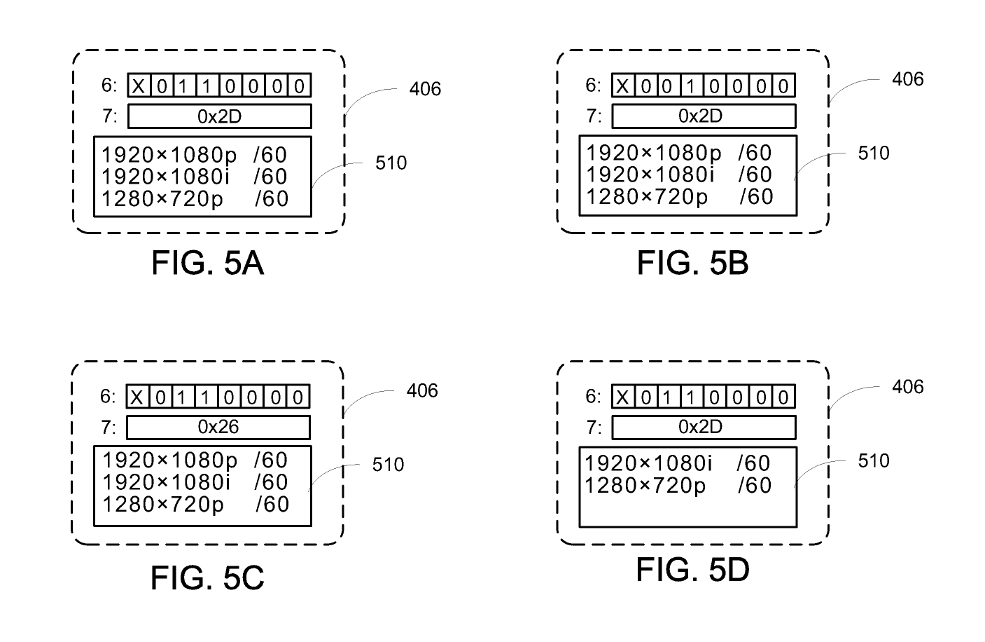

In accordance with the present invention, at least the set value of the sixth byte of the data block, the set value of the seventh byte of the data block or the timing table list is changeable. FIGS. 5A˜5D schematically illustrate various set values of the EDID rewritable memory 406. In FIG. 5A, an initial set value is shown. The initial set value as shown in FIG. 5A may be changed to the set value as shown in FIG. 5B, FIG. 5C or FIG. 5D.

Please refer to the initial set value of FIG. 5A. The set value of the sixth byte of the vendor-specific data block is (x, 0, 1, 1, 0, 0, 0, 0), the set value of the seventh byte of the vendor-specific data block is (0×2D), and the resolutions recorded in the timing table list 510 are 1920×1080p/60 Hz, 1920×1080i/60 Hz, and 1280×720p/60 Hz. From the above settings, the maximum resolution supported by the TV system is 1920×1080p/60 Hz, the maximum deep color video mode supported by the TV system is the 36-bit deep color video mode, and the maximum TMDS clock setting is 225 MHz. Consequently, the TMDS signal group is transmitted from the HDMI transmitter to the TV system according to the highest specification supported by the TV system (i.e. 1920×1080p/60 Hz 36 bit).

After the TMDS signal group is outputted from the player 300 according to the initial set value, if the TV system judges that the quality of the TMDS signal group is bad, the initial set value of the EDID rewritable memory 406 may be changed by the microcontroller 404.

FIG. 5B schematically illustrates a first example of changing the set value. As shown in FIG. 5B, the set value of the sixth byte of the vendor-specific data block is (x, 0, 0, 1, 0, 0, 0, 0), the set value of the seventh byte of the vendor-specific data block is (0×2D), and the resolutions recorded in the timing table list 510 are 1920×1080p/60 Hz, 1920×1080i/60 Hz, and 1280×720p/60 Hz. From the above settings, it is found that the maximum resolution supported by the TV system is 1920×1080p/60 Hz, the maximum deep color video mode supported by the TV system is the 30-bit deep color video mode, and the maximum TMDS clock setting is 225 MHz. Consequently, the TMDS signal group is transmitted from the HDMI transmitter to the TV system according to the highest specification supported by the TV system (i.e. 1920×1080p/60 Hz 30 bit).

After the HPD pin is triggered, according to the updated set value, the TMDS signal group from the player 300 only supports the 30-bit deep color video mode. That is, the supportable deep color video mode of the TMDS signal group is reduced from the 36-bit deep color video mode to the 30-bit deep color video mode. Since the transmission speed of the TMDS signal group is decreased, the quality of the TMDS signal group is improved.

FIG. 5C schematically illustrates a second example of changing the set value. As shown in FIG. 5C, the set value of the sixth byte of the vendor-specific data block is (x, 0, 1, 1, 0, 0, 0, 0), the set value of the seventh byte of the vendor-specific data block is (0×26), and the resolutions recorded in the timing table list 510 are 1920×1080p/60 Hz, 1920×1080i/60 Hz, and 1280×720p/60 Hz. From the above settings, it is found that the maximum resolution supported by the TV system is 1920×1080p/60 Hz, the maximum deep color video mode supported by the TV system is the 36-bit deep color video mode, and the maximum TMDS clock setting is 190 MHz. Consequently, the TMDS signal group is transmitted from the HDMI transmitter to the TV system according to the highest specification supported by the TV system (i.e. 1920×1080p/60 Hz 36 bit).

After the HPD pin is triggered, according to the updated set value, the frequency of the clock channel signal (CLK channel signal) of the TMDS signal group is reduced. That is, the frequency of the clock channel signal of the TMDS signal group is reduced from 225 MHz to the 190 MHz. Since the transmission speed of the TMDS signal group is decreased, the quality of the TMDS signal group is improved.

FIG. 5D schematically illustrates a third example of changing the set value. As shown in FIG. 5D, the set value of the sixth byte of the vendor-specific data block is (x, 0, 1, 1, 0, 0, 0, 0), the set value of the seventh byte of the vendor-specific data block is (0×2D), and the resolutions recorded in the timing table list 510 are 1920×1080i/60 Hz and 1280×720p/60 Hz. From the above settings, it is found that the maximum resolution supported by the TV system is 1920×1080i/60 Hz, the maximum deep color video mode supported by the TV system is the 36-bit deep color video mode, and the maximum TMDS clock setting is 225 MHz. Consequently, the TMDS signal group is transmitted from the HDMI transmitter to the TV system according to the highest specification supported by the TV system (i.e. 1920×1080i/60 Hz 36 bit).

After the HPD pin is triggered, according to the updated set value, the supported resolution of the TMDS signal group is 1920×1080i/60 Hz. That is, the supportable resolution of the TMDS signal group is reduced from 920×1080p/60Hz to 920×1080i/60 Hz. Since the transmission speed of the TMDS signal group is decreased, the quality of the TMDS signal group is improved.

From the above discussions, after the TMDS signal group is outputted from the player again according to the updated set value, the transmission speed of the TMDS signal group is decreased. Since the quality of the TMDS signal group at the HDMI receiver is improved, the video/audio signal can be effectively outputted from the TV system.

In the above embodiments, three changeable parameters are employed in the control method for the TV system. Alternatively, two or three parameters are employed in the control method for the TV system. Since the quality of the TMDS signal group at the HDMI receiver is improved, the video/audio signal can be effectively outputted from the TV system.

It is noted that numerous modifications and alterations may be made while retaining the teachings of the invention. For example, If the quality signal SS indicates that the quality of the TMDS signal group is good, the set value as shown in FIG. 5B, 5C or 5D may be restored to the initial set value as shown in FIG. 5A, and then the HPD pin is triggered again, so that the transmission speed of the TMDS signal group is increased.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A control method for a TV system, the TV system having a digital signal port connected to a player, the control method comprising steps of:
(a) turning on the TV system, and writing a first set value into an extended display identification data (EDID) rewritable memory of the TV system;
(b) the player reading the first set value of the EDID rewritable memory to acquire a first specification supported by the TV system after the player is connected to the TV system, so that a first digital signal group is transmitted from the player to the TV system;
(c) the TV system judging whether a quality of the first digital signal group is good or bad;
(d) if the quality of the first digital signal group is good, the TV system outputting a video/audio signal according to the first digital signal group; and
(e) if the quality of the first digital signal group is bad, writing a second set value into the EDID rewritable memory.

2. The control method as claimed in claim 1, after the step (e), the control method further comprises steps of:
(f) triggering a hot-plug detecting pin of the digital signal port;
(g) the player reading the second set value of the EDID rewritable memory to acquire a second specification supported by the TV system, thereby transmitting a second digital signal group to the TV system;
(h) the TV system judging whether a quality of the second digital signal group is good or bad;
(i) if the quality of the second digital signal group is good, the TV system outputting the video/audio signal according to the second digital signal group; and
(j) if the quality of the second digital signal group is bad, writing a third set value into the EDID rewritable memory.

3. The control method as claimed in claim 2, wherein for performing the step (f), the hot-plug detecting pin is switched from a high voltage level to a low voltage level for a time period and then returned to the high voltage level.

4. The control method as claimed in claim 2, wherein the first digital signal group is transmitted at a first transmission speed according to the first set value, and the second digital signal group is transmitted at a second transmission speed according to the second set value, wherein the first transmission speed is higher than the second transmission speed.

5. The control method as claimed in claim 2, wherein the first digital signal group with a m-bit deep color video mode is generated by the player according to the first set value, and the second digital signal group with an n-bit deep color video mode is generated by the player according to the second set value, wherein m is higher than n.

6. The control method as claimed in claim 2, wherein a clock channel signal with a first frequency is generated by the player according to the first set value, and the clock channel signal with a second frequency is generated by the player according to the second set value, wherein the frequency is higher than the second frequency.

7. The control method as claimed in claim 2, wherein the first digital signal group with a first resolution is generated by the player according to the first set value, and the second digital signal group with a second resolution is generated by the player according to the second set value, wherein the first resolution is higher than the second resolution.

8. The control method as claimed in claim 1, wherein the step (c) comprises a sub-step of converting the first digital signal group into a video signal, wherein if a horizontal synchronization signal and a vertical synchronization signal contained in the video signal are accurate, the quality of the first digital signal group is good, wherein if the horizontal synchronization signal and the vertical synchronization signal contained in the video signal are inaccurate, the quality of the first digital signal group is bad.

9. The control method as claimed in claim 1, wherein the digital signal port is a high-definition multimedia interface (HDMI) port, and the first digital signal group is a transition minimized differential signaling (TMDS) signal group comprising a channel 0 signal, a channel 1 signal, a channel 2 signal, and a clock channel signal.
